(19) United States
(12) Patent Application Publication
(10) Pub. No.: US 2024/0281526 A1
(43) Pub. Date: Aug. 22, 2024

(54) ADVERSARY ALERTING AND PROCESSING SYSTEM (ALPS)

(71) Applicant: Snowflake Inc., Bozeman, MT (US)

(72) Inventors: Jason A. Brault, Peoria, AZ (US); LIoyd Alexander Windle, III, Tuscon, AZ (US)

(21) Appl. No.: 18/172,629

(22) Filed: Feb. 22, 2023

(51) Int. Cl. G06F 21/55; G06F 21/60

(52) U.S. Cl. CPC G06F 21/554; G06F 21/604

(57) ABSTRACT

Provided herein are systems and methods for adversary alerting and processing. A system includes at least one hardware processor coupled to a memory and configured to retrieve log data associated with user access to network functionality. At least one security alert associated with the user access is generated based on the log data. One or more indicators of compromise and identification information of a user are extracted from the at least one security alert. Enriched metadata of the user is generated based on the identification information. A remediation action for the at least one security alert is performed based on the one or more indicators of compromise and the enriched metadata.

### TECHNICAL FIELD

Embodiments of the disclosure relate generally to security alert processing in a database system and, more specifically, to an adversary alerting and processing system (ALPS).

### BACKGROUND

Databases are widely used for data storage and access in computing applications. A goal of database storage is to provide enormous sums of information in an organized manner so that it can be accessed, managed, updated, and shared. In a database, data may be organized into rows, columns, and tables. Databases are used by various entities and companies for storing information that may need to be accessed or analyzed.

Cloud-based data warehouses and other cloud database systems or data platforms are susceptible to network attacks and breaches such as phishing, malware attacks, and other cybersecurity risks. However, generating security alerts (also referred to as “adversary alerting”) and alert triaging can be time-consuming resulting in reduced response times and network security breaches.

### BRIEF DESCRIPTION OF THE DRAWINGS

The present disclosure will be understood more fully from the detailed description given below and from the accompanying drawings of various embodiments of the disclosure.

FIG. 1 illustrates an example computing environment that includes a network-based database system in communication with a cloud storage platform, according to some example embodiments.

FIG. 2 is a block diagram illustrating the components of a compute service manager, according to some example embodiments.

FIG. 3 is a block diagram illustrating components of an execution platform, according to some example embodiments.

FIG. 4 is a block diagram of an example adversary alerting and processing system which can be used within the network-based database system of FIG. 1, according to some example embodiments.

FIG. 5, FIG. 6, FIG. 7, and FIG. 8 are flow diagrams illustrating the operations of an adversary alerting and processing manager in performing methods for processing security alerts, according to some example embodiments.

FIG. 9 illustrates a diagrammatic representation of a machine in the form of a computer system within which a set of instructions may be executed for causing the machine to perform any one or more of the methodologies discussed herein, according to some example embodiments.

### DETAILED DESCRIPTION

Reference will now be made in detail to specific example embodiments for carrying out the inventive subject matter. Examples of these specific embodiments are illustrated in the accompanying drawings, and specific details are outlined in the following description to provide a thorough understanding of the subject matter. It will be understood that these examples are not intended to limit the scope of the claims to the illustrated embodiments. On the contrary, they are intended to cover such alternatives, modifications, and equivalents as may be included within the scope of the disclosure.

In the present disclosure, physical units of data that are stored in a data platform—and that make up the content of, e.g., database tables in customer accounts—are referred to as micro-partitions. In different implementations, a data platform may store metadata in micro-partitions as well. The term “micro-partitions” is distinguished in this disclosure from the term “files,” which, as used herein, refers to data units such as image files (e.g., Joint Photographic Experts Group (JPEG) files, Portable Network Graphics (PNG) files, etc.), video files (e.g., Moving Picture Experts Group (MPEG) files, MPEG-4 (MP4) files, Advanced Video Coding High Definition (AVCHD) files, etc.), Portable Document Format (PDF) files, documents that are formatted to be compatible with one or more word-processing applications, documents that are formatted to be compatible with one or more spreadsheet applications, and/or the like. If stored internal to the data platform, a given file is referred to herein as an “internal file” and may be stored in (or at, or on, etc.) what is referred to herein as an “internal storage location.” If stored external to the data platform, a given file is referred to herein as an “external file” and is referred to as being stored in (or at, or on, etc.) what is referred to herein as an “external storage location.” These terms are further discussed below.

Computer-readable files come in several varieties, including unstructured files, semi-structured files, and structured files. These terms may mean different things to different people. As used herein, examples of unstructured files include image files, video files, PDFs, audio files, and the like; examples of semi-structured files include JavaScript Object Notation (JSON) files, extensible Markup Language (XML) files, and the like; and examples of structured files include Variant Call Format (VCF) files, Keithley Data File (KDF) files, Hierarchical Data Format version 5 (HDF5) files, and the like. As known to those of skill in the relevant arts, VCF files are often used in the bioinformatics field for storing, e.g., gene-sequence variations, KDF files are often used in the semiconductor industry for storing, e.g., semiconductor-testing data, and HDF5 files are often used in industries such as the aeronautics industry, in that case for storing data such as aircraft-emissions data. Numerous other example unstructured-file types, semi-structured-file types, and structured-file types, as well as example uses thereof, could certainly be listed here as well and will be familiar to those of skill in the relevant arts. Different people of skill in the relevant arts may classify types of files differently among these categories and may use one or more different categories instead of or in addition to one or more of these.

Data platforms are widely used for data storage and data access in computing and communication contexts. Concerning architecture, a data platform could be an on-premises data platform, a network-based data platform (e.g., a cloud-based data platform), a combination of the two, and/or include another type of architecture. Concerning the type of data processing, a data platform could implement online analytical processing (OLAP), online transactional processing (OLTP), a combination of the two, and/or another type of data processing. Moreover, a data platform could be or include a relational database management system (RDBMS) and/or one or more other types of database management systems.

In a typical implementation, a data platform may include one or more databases that are respectively maintained in association with any number of customer accounts (e.g., accounts of one or more data providers), as well as one or more databases associated with a system account (e.g., an administrative account) of the data platform, one or more other databases used for administrative purposes, and/or one or more other databases that are maintained in association with one or more other organizations and/or for any other purposes. A data platform may also store metadata (e.g., account object metadata) in association with the data platform in general and in association with, for example, particular databases and/or particular customer accounts as well. Users and/or executing processes that are associated with a given customer account may, via one or more types of clients, be able to cause data to be ingested into the database, and may also be able to manipulate the data, add additional data, remove data, run queries against the data, generate views of the data, and so forth. As used herein, the terms “account object metadata” and “account object” are used interchangeably.

In an implementation of a data platform, a given database (e.g., a database maintained for a customer account) may reside as an object within, e.g., a customer account, which may also include one or more other objects (e.g., users, roles, grants, shares, warehouses, resource monitors, integrations, network policies, and/or the like). Furthermore, a given object such as a database may itself contain one or more objects such as schemas, tables, materialized views, and/or the like. A given table may be organized as a collection of records (e.g., rows) so that each includes a plurality of attributes (e.g., columns). In some implementations, database data is physically stored across multiple storage units, which may be referred to as files, blocks, partitions, micro-partitions, and/or by one or more other names. In many cases, a database on a data platform serves as a backend for one or more applications that are executing on one or more application servers.

The disclosed adversary alerting and processing (AAP) techniques can be used to improve security alert triaging and response effectiveness in addressing network cybersecurity threats and attacks. For example, the disclosed AAP manager can be configured to use a security data lake (e.g., a database with security-related information) to enrich detected security alerts as well as to generate auto-responses (e.g., notifications and remediation actions) to such security alerts. Additionally, the AAP manager can be configured to extract information from the detected security alert (e.g., indicators of compromise, phishing metrics, and other observables such as Internet Protocol (IP) addresses, domains, uniform resource locators (URLs), emails, etc.) and update the database of the security data lake.

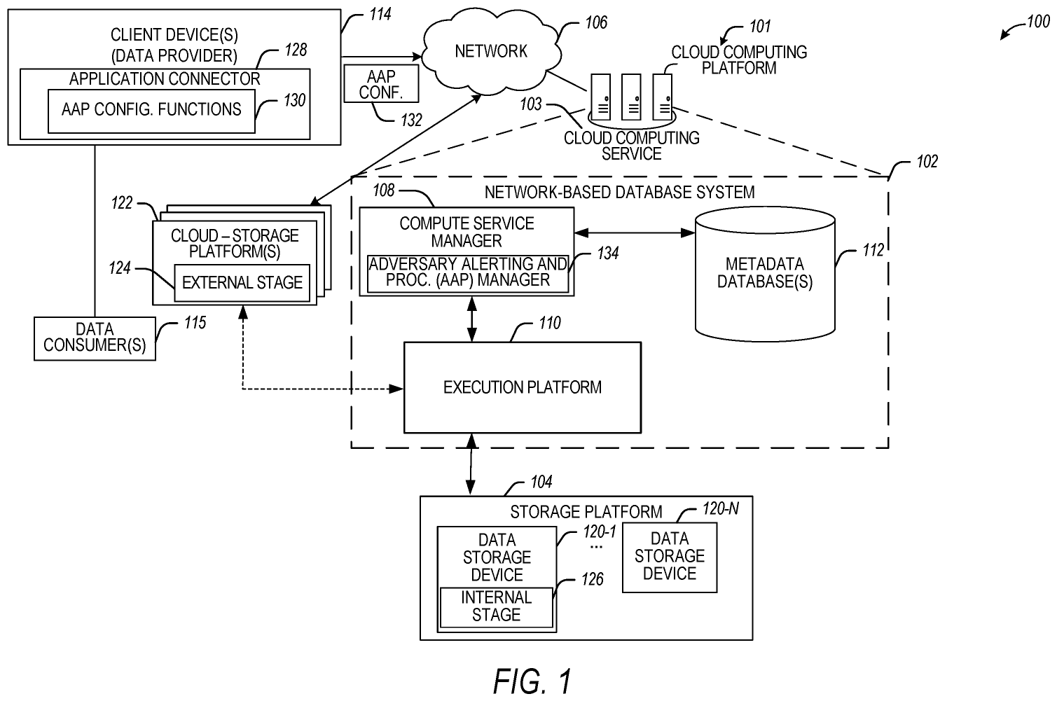

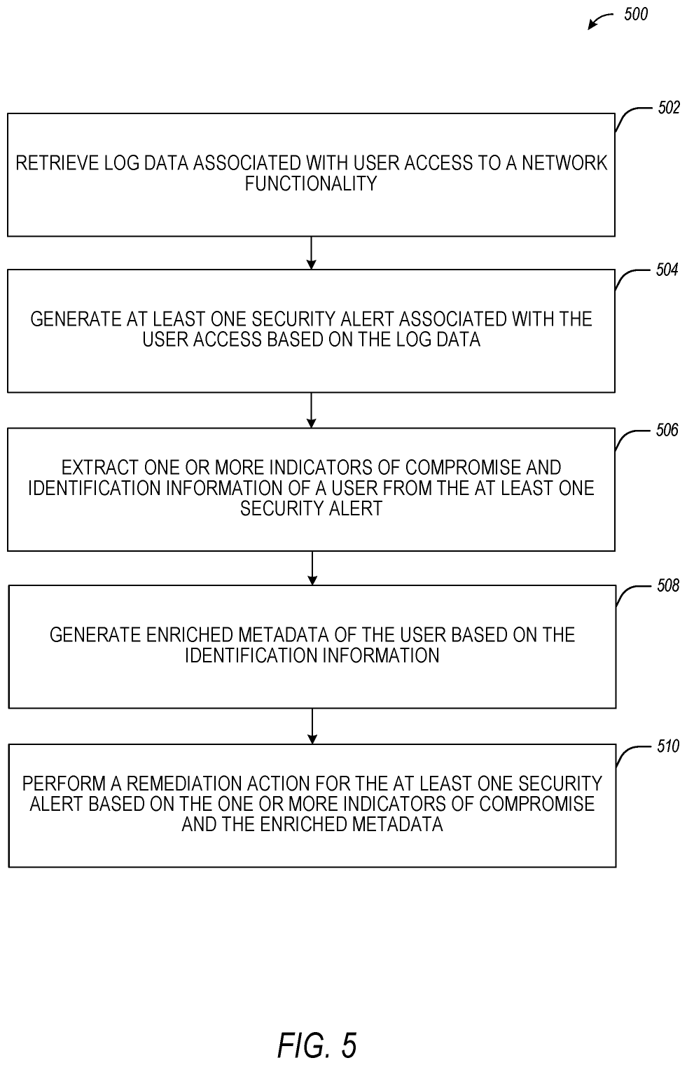

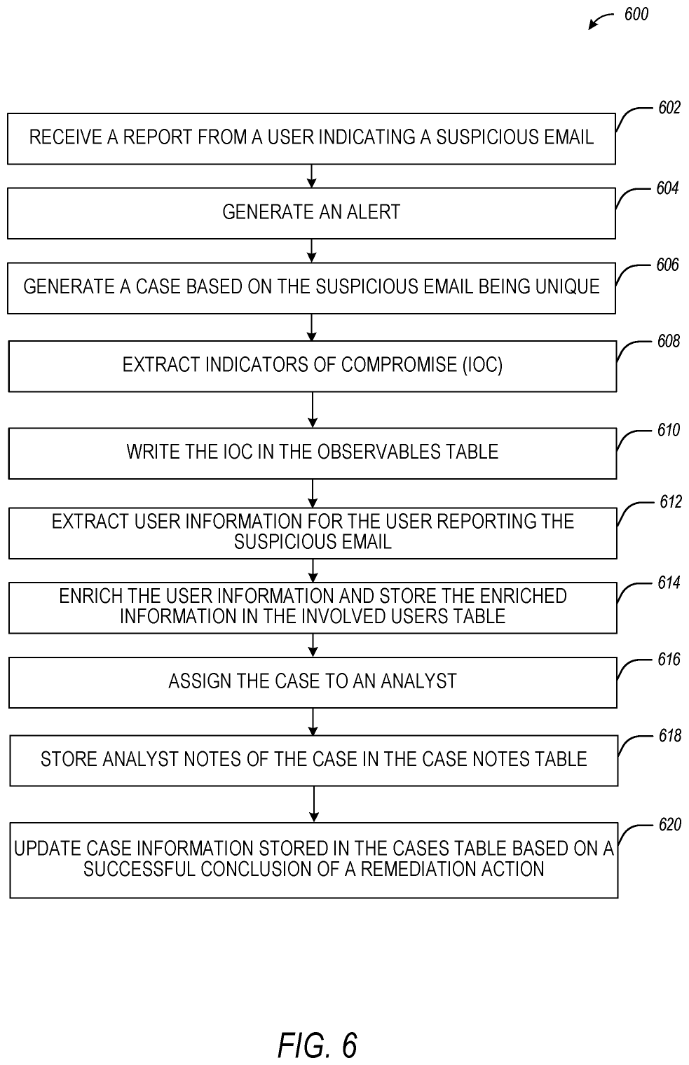

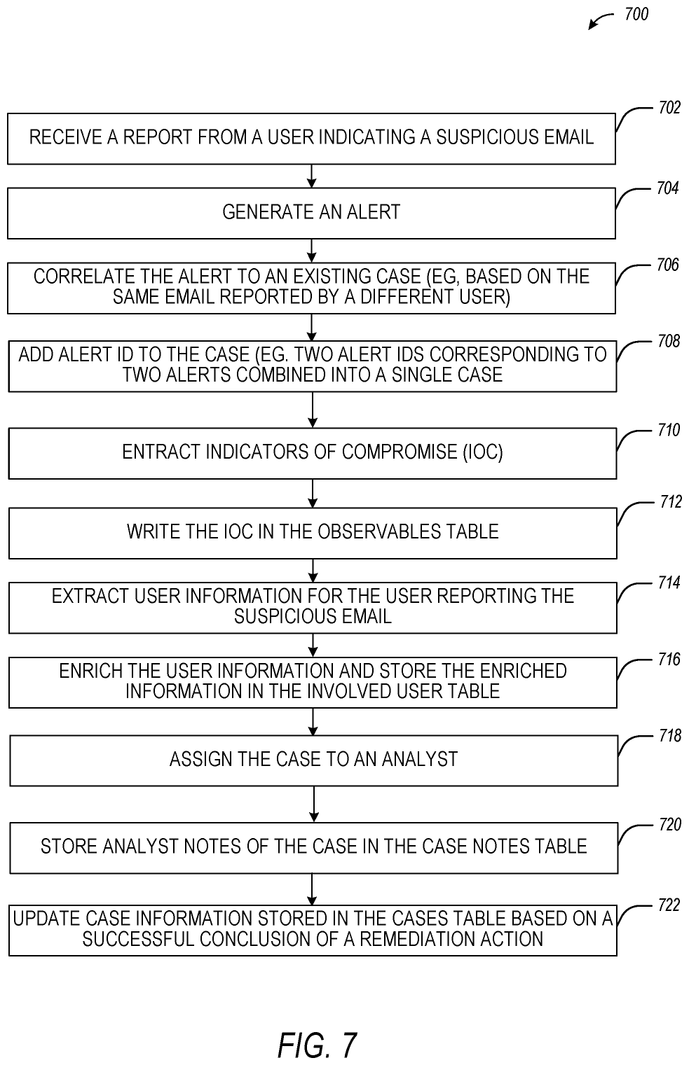

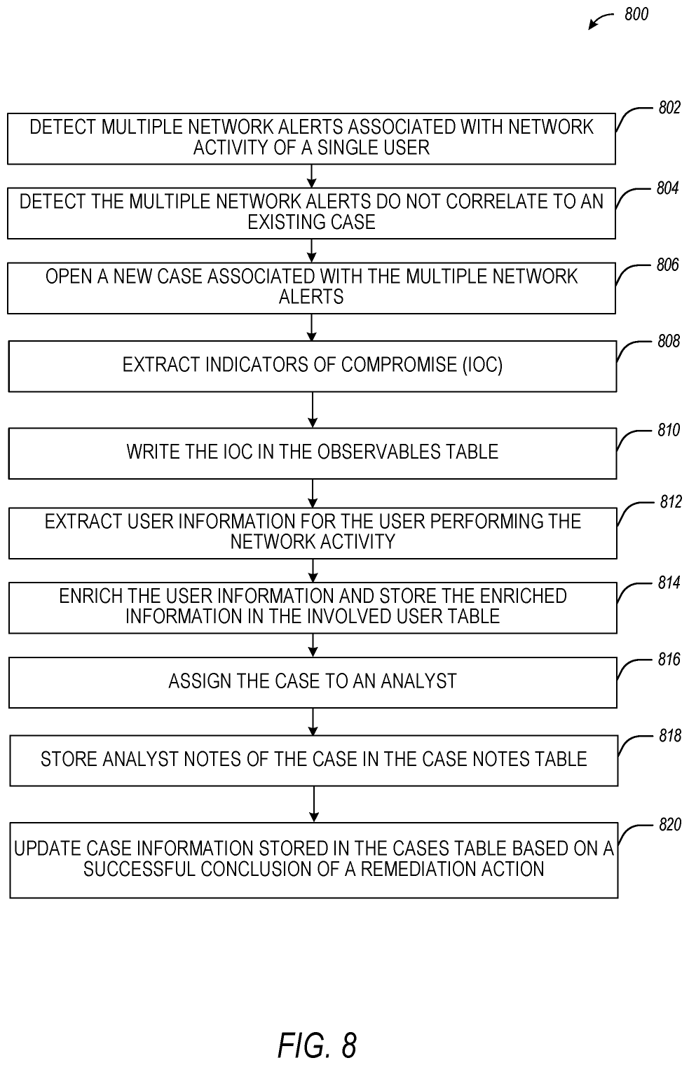

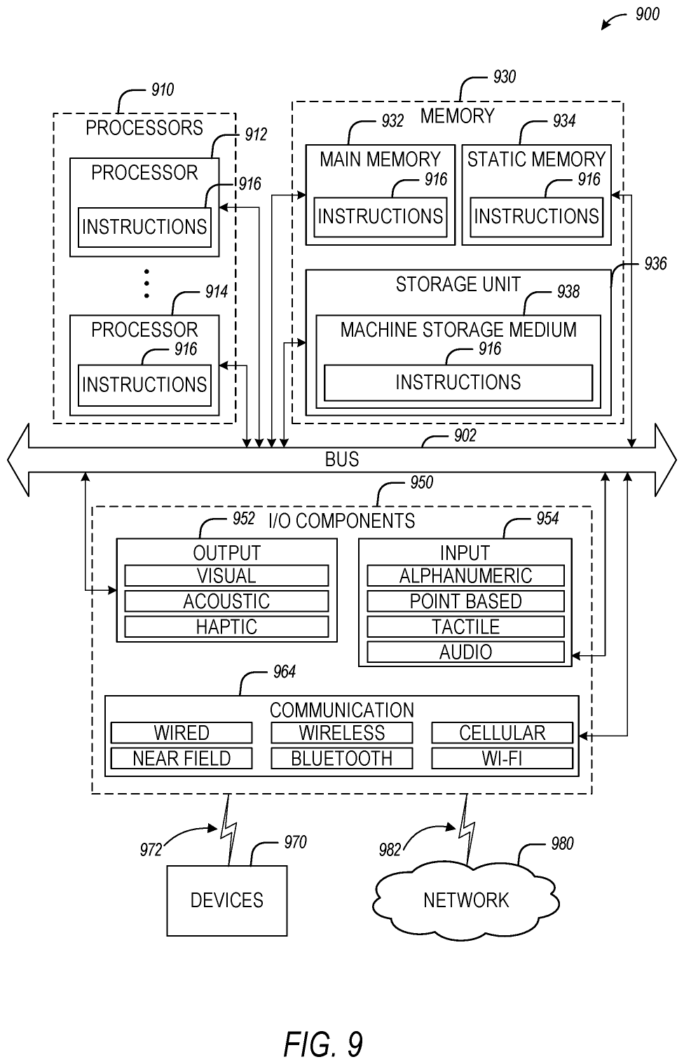

The various embodiments that are described herein are described with reference where appropriate to one or more of the various figures. An example computing environment including an AAP manager configured to perform AAP-related functions is discussed in connection with FIGS. 1-3. Example AAP functionalities performed by the AAP manager in connection with ALPS are discussed in connection with FIG. 4. Example methods for AAP-related functions including alert processing are discussed in connection with FIGS. 5-8. A more detailed discussion of example computing devices that may be used with the disclosed techniques is provided in connection with FIG. 9.

FIG. 1 illustrates an example computing environment 100 that includes a database system in the example form of a network-based database system 102, according to some example embodiments. To avoid obscuring the inventive subject matter with unnecessary detail, various functional components that are not germane to conveying an understanding of the inventive subject matter have been omitted from FIG. 1. However, a skilled artisan will readily recognize that various additional functional components may be included as part of the computing environment 100 to facilitate additional functionality that is not specifically described herein. In other embodiments, the computing environment may comprise another type of network-based database system or a cloud data platform. For example, in some aspects, the computing environment 100 may include a cloud computing platform 101 with the network-based database system 102, and a storage platform 104 (also referred to as a cloud storage platform). The cloud computing platform 101 provides computing resources and storage resources that may be acquired (purchased) or leased and configured to execute applications and store data.

The cloud computing platform 101 may host a cloud computing service 103 that facilitates storage of data on the cloud computing platform 101 (e.g., data management and access) and analysis functions (e.g. SQL queries, analysis), as well as other processing capabilities (e.g., configuring replication group objects as described herein). The cloud computing platform 101 may include a three-tier architecture: data storage (e.g., storage platforms 104 and 122), an execution platform 110 (e.g., providing query processing), and a compute service manager 108 providing cloud services.

It is often the case that organizations that are customers of a given data platform also maintain data storage (e.g., a data lake) that is external to the data platform (i.e., one or more external storage locations). For example, a company could be a customer of a particular data platform and also separately maintain storage of any number of files—be they unstructured files, semi-structured files, structured files, and/or files of one or more other types—on, as examples, one or more of their servers and/or on one or more cloud-storage platforms such as AMAZON WEB SERVICES™ (AWS™), MICROSOFT® AZURE®, GOOGLE CLOUD PLATFORM™, and/or the like. The customer's servers and cloud-storage platforms are both examples of what a given customer could use as what is referred to herein as an external storage location. The cloud computing platform 101 could also use a cloud-storage platform as what is referred to herein as an internal storage location concerning the data platform.

From the perspective of the network-based database system 102 of the cloud computing platform 101, one or more files that are stored at one or more storage locations are referred to herein as being organized into one or more of what is referred to herein as either “internal stages” or “external stages.” Internal stages are stages that correspond to data storage at one or more internal storage locations, and where external stages are stages that correspond to data storage at one or more external storage locations. In this regard, external files can be stored in external stages at one or more external storage locations, and internal files can be stored in internal stages at one or more internal storage locations, which can include servers managed and controlled by the same organization (e.g., company) that manages and controls the data platform, and which can instead or in addition include data-storage resources operated by a storage provider (e.g., a cloud-storage platform) that is used by the data platform for its “internal” storage. The internal storage of a data platform is also referred to herein as the “storage platform” of the data platform. It is further noted that a given external file that a given customer stores at a given external storage location may or may not be stored in an external stage in the external storage location—i.e., in some data-platform implementations, it is a customer's choice whether to create one or more external stages (e.g., one or more external-stage objects) in the customer's data-platform account as an organizational and functional construct for conveniently interacting via the data platform with one or more external files.

As shown, the network-based database system 102 of the cloud computing platform 101 is in communication with the cloud storage platforms 104 and 122 (e.g., AWS®, Microsoft Azure Blob Storage®, or Google Cloud Storage). The network-based database system 102 is a network-based system used for reporting and analysis of integrated data from one or more disparate sources including one or more storage locations within the cloud storage platform 104. The cloud storage platform 104 comprises a plurality of computing machines and provides on-demand computer system resources such as data storage and computing power to the network-based database system 102.

The network-based database system 102 comprises a compute service manager 108, an execution platform 110, and one or more metadata databases 112. The network-based database system 102 hosts and provides data reporting and analysis services to multiple client accounts.

The compute service manager 108 coordinates and manages operations of the network-based database system 102. The compute service manager 108 also performs query optimization and compilation as well as managing clusters of computing services that provide compute resources (also referred to as “virtual warehouses”). The compute service manager 108 can support any number of client accounts such as end-users providing data storage and retrieval requests, system administrators managing the systems and methods described herein, and other components/devices that interact with compute service manager 108.

The compute service manager 108 is also in communication with a client device 114. The client device 114 corresponds to a user of one of the multiple client accounts supported by the network-based database system 102. A user may utilize the client device 114 to submit data storage, retrieval, and analysis requests to the compute service manager 108. Client device 114 (also referred to as remote computing device or user device 114) may include one or more of a laptop computer, a desktop computer, a mobile phone (e.g., a smartphone), a tablet computer, a cloud-hosted computer, cloud-hosted serverless processes, or other computing processes or devices may be used (e.g., by a data provider) to access services provided by the cloud computing platform 101 (e.g., cloud computing service 103) by way of a network 106, such as the Internet or a private network. A data consumer 115 can use another computing device to access the data of the data provider (e.g., data obtained via the client device 114).

In the description below, actions are ascribed to users, particularly consumers and providers. Such actions shall be understood to be performed concerning client device (or devices) 114 operated by such users. For example, a notification to a user may be understood to be a notification transmitted to the client device 114, input or instruction from a user may be understood to be received by way of the client device 114, and interaction with an interface by a user shall be understood to be interaction with the interface on the client device 114. In addition, database operations (joining, aggregating, analysis, etc.) ascribed to a user (consumer or provider) shall be understood to include performing such actions by the cloud computing service 103 in response to an instruction from that user.

In some embodiments, the client device 114 is configured with an application connector 128, which may be configured to perform UAR configuration functions 130. For example, the AAP configuration functions 130 are used to generate one or more AAP configurations 132 for communication to the network-based database system 102 via network 106. For example, AAP configurations 132 can be communicated to AAP manager 134 within the compute service manager 108. The AAP manager 134 can use the AAP configurations to configure AAP functionalities or one or more of the tables used in connection with providing AAP functionalities (e.g., one or more of the tables discussed in connection with FIG. 4).

The compute service manager 108 is also coupled to one or more metadata databases 112 that store metadata about various functions and aspects associated with the network-based database system 102 and its users. For example, a metadata database 112 may include a summary of data stored in remote data storage systems as well as data available from a local cache. Additionally, a metadata database 112 may include information regarding how data is organized in remote data storage systems (e.g., the cloud storage platform 104) and the local caches. Information stored by a metadata database 112 allows systems and services to determine whether a piece of data needs to be accessed without loading or accessing the actual data from a storage device. In some embodiments, metadata database 112 is configured to store account object metadata (e.g., account objects used in connection with a replication group object).

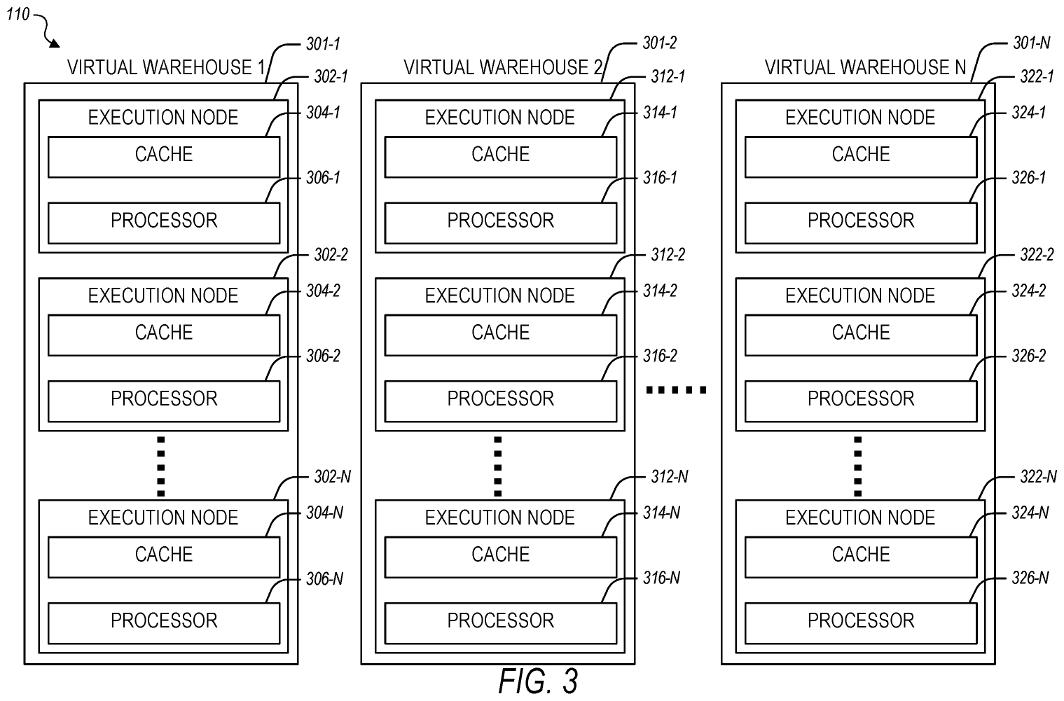

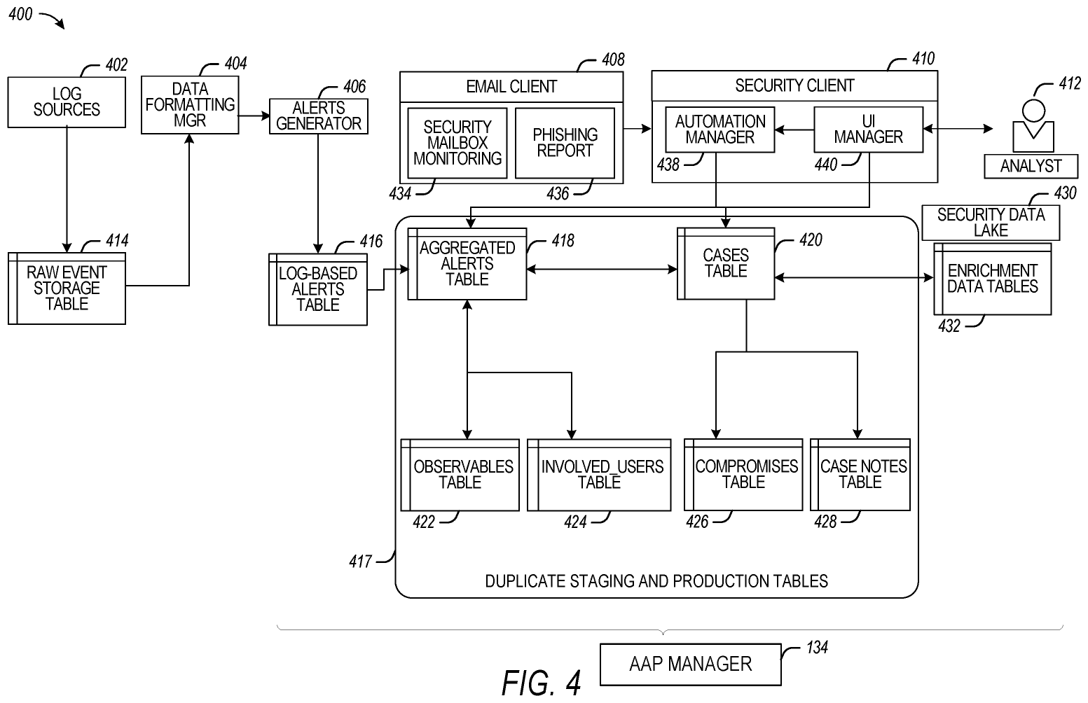

The compute service manager 108 is further coupled to the execution platform 110, which provides multiple computing resources that execute various data storage and data retrieval tasks. As illustrated in FIG. 3, the execution platform 110 comprises a plurality of compute nodes. The execution platform 110 is coupled to storage platform 104 and cloud storage platforms 122. The storage platform 104 comprises multiple data storage devices 120-1 to 120-N. In some embodiments, the data storage devices 120-1 to 120-N are cloud-based storage devices located in one or more geographic locations. For example, the data storage devices 120-1 to 120-N may be part of a public cloud infrastructure or a private cloud infrastructure. The data storage devices 120-1 to 120-N may be hard disk drives (HDDs), solid-state drives (SSDs), storage clusters, Amazon S3™ storage systems, or any other data-storage technology. Additionally, the cloud storage platform 104 may include distributed file systems (such as Hadoop Distributed File Systems (HDFS)), object storage systems, and the like. In some embodiments, at least one internal stage 126 may reside on one or more of the data storage devices 120-1-120-N, and at least one external stage 124 may reside on one or more of the cloud storage platforms 122.

In some embodiments, the compute service manager 108 includes the AAP manager 134. The AAP manager 134 comprises suitable circuitry, interfaces, logic, and/or code and is configured to perform AAP-related functions which can be based (at least partially) on one or more of the AAP configurations 132. For example, the AAP manager 134 can configure one or more of the AAP functionalities discussed in connection with FIGS. 4-8 based on the AAP configurations 132. For example, the AAP configurations 132 can be used to configure alert generation, alert correlation in connection with a case generation, retrieve observables data from a generated alert, enrich an alert using a security data lake with security-related information, detect compromises in connection with an alert, and configuring one or more database tables associated with AAP-related functions (e.g., as discussed in connection with FIGS. 4-8).

In some embodiments, communication links between elements of the computing environment 100 are implemented via one or more data communication networks. These data communication networks may utilize any communication protocol and any type of communication medium. In some embodiments, the data communication networks are a combination of two or more data communication networks (or sub-Networks) coupled to one another. In alternate embodiments, these communication links are implemented using any type of communication medium and any communication protocol.

The compute service manager 108, metadata database(s) 112, execution platform 110, and storage platform 104, are shown in FIG. 1 as individual discrete components. However, each of the compute service manager 108, metadata database(s) 112, execution platform 110, and storage platform 104 may be implemented as a distributed system (e.g., distributed across multiple systems/platforms at multiple geographic locations). Additionally, each of the compute service manager 108, metadata database(s) 112, execution platform 110, and storage platform 104 can be scaled up or down (independently of one another) depending on changes to the requests received and the changing needs of the network-based database system 102. Thus, in the described embodiments, the network-based database system 102 is dynamic and supports regular changes to meet the current data processing needs.

During a typical operation, the network-based database system 102 processes multiple jobs determined by the compute service manager 108. These jobs are scheduled and managed by the compute service manager 108 to determine when and how to execute the job. For example, the compute service manager 108 may divide the job into multiple discrete tasks and may determine what data is needed to execute each of the multiple discrete tasks. The compute service manager 108 may assign each of the multiple discrete tasks to one or more nodes of the execution platform 110 to process the task. The compute service manager 108 may determine what data is needed to process a task and further determine which nodes within the execution platform 110 are best suited to process the task. Some nodes may have already cached the data needed to process the task and, therefore, be a good candidate for processing the task. Metadata stored in a metadata database 112 assists the compute service manager 108 in determining which nodes in the execution platform 110 have already cached at least a portion of the data needed to process the task. One or more nodes in the execution platform 110 process the task using data cached by the nodes and, if necessary, data retrieved from the cloud storage platform 104. It is desirable to retrieve as much data as possible from caches within the execution platform 110 because the retrieval speed is typically much faster than retrieving data from the cloud storage platform 104.

As shown in FIG. 1, the cloud computing platform 101 of the computing environment 100 separates the execution platform 110 from the storage platform 104. In this arrangement, the processing resources and cache resources in the execution platform 110 operate independently of the data storage devices 120-1 to 120-N in the cloud storage platform 104. Thus, the computing resources and cache resources are not restricted to specific data storage devices 120-1 to 120-N. Instead, all computing resources and all cache resources may retrieve data from, and store data to, any of the data storage resources in the cloud storage platform 104.

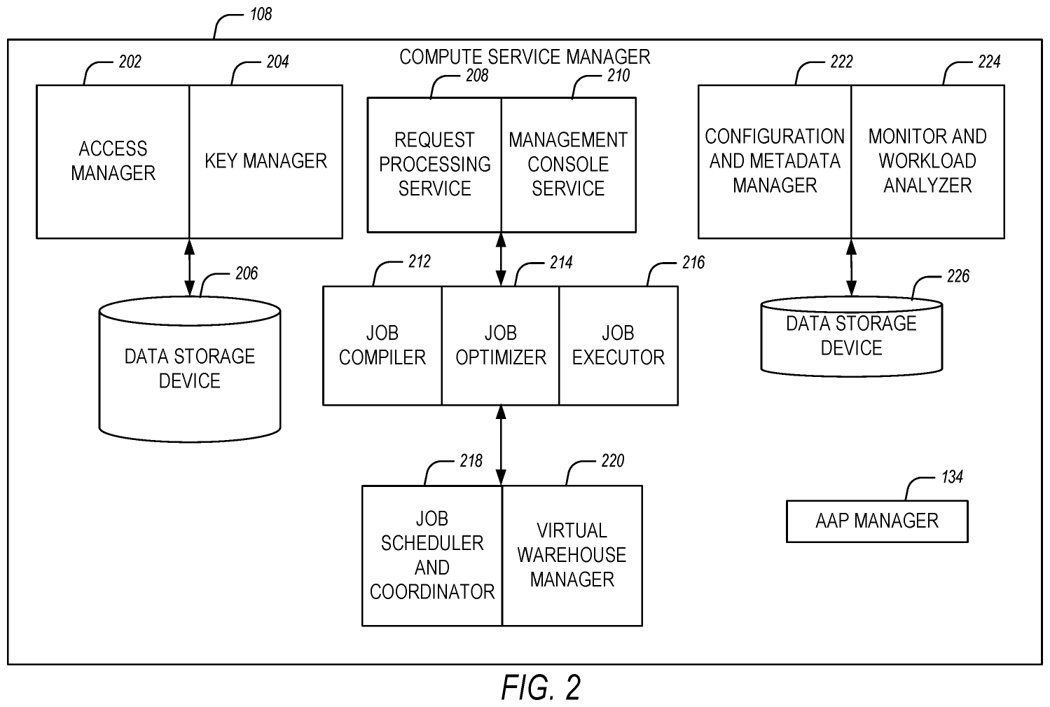

FIG. 2 is a block diagram illustrating components of the compute service manager 108, according to some example embodiments. As shown in FIG. 2, the compute service manager 108 includes an access manager 202 and a key manager 204 coupled to an access metadata database 206, which is an example of the metadata database(s) 112. Access manager 202 handles authentication and authorization tasks for the systems described herein. The key manager 204 facilitates the use of remotely stored credentials to access external resources such as data resources in a remote storage device. As used herein, the remote storage devices may also be referred to as “persistent storage devices” or “shared storage devices.” For example, the key manager 204 may create and maintain remote credential store definitions and credential objects (e.g., in the access metadata database 206). A remote credential store definition identifies a remote credential store and includes access information to access security credentials from the remote credential store. A credential object identifies one or more security credentials using non-sensitive information (e.g., text strings) that are to be retrieved from a remote credential store for use in accessing an external resource. When a request invoking an external resource is received at run time, the key manager 204 and access manager 202 use information stored in the access metadata database 206 (e.g., a credential object and a credential store definition) to retrieve security credentials used to access the external resource from a remote credential store.

A request processing service 208 manages received data storage requests and data retrieval requests (e.g., jobs to be performed on database data). For example, the request processing service 208 may determine the data to process a received query (e.g., a data storage request or data retrieval request). The data may be stored in a cache within the execution platform 110 or in a data storage device in storage platform 104.

A management console service 210 supports access to various systems and processes by administrators and other system managers. Additionally, the management console service 210 may receive a request to execute a job and monitor the workload on the system.

The compute service manager 108 also includes a job compiler 212, a job optimizer 214, and a job executor 216. The job compiler 212 parses a job into multiple discrete tasks and generates the execution code for each of the multiple discrete tasks. The job optimizer 214 determines the best method to execute the multiple discrete tasks based on the data that needs to be processed. Job optimizer 214 also handles various data pruning operations and other data optimization techniques to improve the speed and efficiency of executing the job. The job executor 216 executes the execution code for jobs received from a queue or determined by the compute service manager 108.

A job scheduler and coordinator 218 sends received jobs to the appropriate services or systems for compilation, optimization, and dispatch to the execution platform 110. For example, jobs may be prioritized and then processed in that prioritized order. In an embodiment, the job scheduler and coordinator 218 determines a priority for internal jobs that are scheduled by the compute service manager 108 with other “outside” jobs such as user queries that may be scheduled by other systems in the database but may utilize the same processing resources in the execution platform 110. In some embodiments, the job scheduler and coordinator 218 identifies or assigns particular nodes in the execution platform 110 to process particular tasks. A virtual warehouse manager 220 manages the operation of multiple virtual warehouses implemented in the execution platform 110. For example, the virtual warehouse manager 220 may generate query plans for executing received queries.

Additionally, the compute service manager 108 includes configuration and metadata manager 222, which manages the information related to the data stored in the remote data storage devices and the local buffers (e.g., the buffers in execution platform 110). Configuration and metadata manager 222 uses metadata to determine which data files need to be accessed to retrieve data for processing a particular task or job. A monitor and workload analyzer 224 oversees processes performed by the compute service manager 108 and manages the distribution of tasks (e.g., workload) across the virtual warehouses and execution nodes in the execution platform 110. The monitor and workload analyzer 224 also redistributes tasks, as needed, based on changing workloads throughout the network-based database system 102 and may further redistribute tasks based on a user (e.g., “external”) query workload that may also be processed by the execution platform 110. The configuration and metadata manager 222 and the monitor and workload analyzer 224 are coupled to a data storage device 226. The data storage device 226 in FIG. 2 represents any data storage device within the network-based database system 102. For example, data storage device 226 may represent buffers in execution platform 110, storage devices in storage platform 104, or any other storage device.

As described in embodiments herein, the compute service manager 108 validates all communication from an execution platform (e.g., the execution platform 110) to validate that the content and context of that communication are consistent with the task(s) known to be assigned to the execution platform. For example, an instance of the execution platform executing query A should not be allowed to request access to data source D (e.g., data storage device 226) that is not relevant to query A. Similarly, a given execution node (e.g., execution node 302-1 may need to communicate with another execution node (e.g., execution node 302-2), and should be disallowed from communicating with a third execution node (e.g., execution node 312-1) and any such illicit communication can be recorded (e.g., in a log or other location). Also, the information stored on a given execution node is restricted to data relevant to the current query and any other data is unusable, rendered so by destruction or encryption where the key is unavailable.

As previously mentioned, the compute service manager 108 includes the AAP manager 134 configured to perform the disclosed AAP functionalities which are discussed in connection with at least FIGS. 4-8.

FIG. 3 is a block diagram illustrating components of the execution platform 110, according to some example embodiments. As shown in FIG. 3, the execution platform 110 includes multiple virtual warehouses, including virtual warehouse 1 (or 301-1), virtual warehouse 2 (or 301-2), and virtual warehouse N (or 301-N). Each virtual warehouse includes multiple execution nodes that each include a data cache and a processor. The virtual warehouses can execute multiple tasks in parallel by using multiple execution nodes. As discussed herein, the execution platform 110 can add new virtual warehouses and drop existing virtual warehouses in real time based on the current processing needs of the systems and users. This flexibility allows the execution platform 110 to quickly deploy large amounts of computing resources when needed without being forced to continue paying for those computing resources when they are no longer needed. All virtual warehouses can access data from any data storage device (e.g., any storage device in the cloud storage platform 104).

Although each virtual warehouse shown in FIG. 3 includes three execution nodes, a particular virtual warehouse may include any number of execution nodes. Further, the number of execution nodes in a virtual warehouse is dynamic, such that new execution nodes are created when additional demand is present, and existing execution nodes are deleted when they are no longer necessary.

Each virtual warehouse is capable of accessing any of the data storage devices 120-1 to 120-N shown in FIG. 1. Thus, the virtual warehouses are not necessarily assigned to a specific data storage device 120-1 to 120-N and, instead, can access data from any of the data storage devices 120-1 to 120-N within the cloud storage platform 104. Similarly, each of the execution nodes shown in FIG. 3 can access data from any of the data storage devices 120-1 to 120-N. In some embodiments, a particular virtual warehouse or a particular execution node may be temporarily assigned to a specific data storage device, but the virtual warehouse or execution node may later access data from any other data storage device.

In the example of FIG. 3, virtual warehouse 1 includes three execution nodes 302-1, 302-2, and 302-N. Execution node 302-1 includes a cache 304-1 and a processor 306-1. Execution node 302-2 includes a cache 304-2 and a processor 306-2. Execution node 302-N includes a cache 304-N and a processor 306-N. Each execution node 302-1, 302-2, and 302-N is associated with processing one or more data storage and/or data retrieval tasks. For example, a virtual warehouse may handle data storage and data retrieval tasks associated with an internal service, such as a clustering service, a materialized view refresh service, a file compaction service, a storage procedure service, or a file upgrade service. In other implementations, a particular virtual warehouse may handle data storage and data retrieval tasks associated with a particular data storage system or a particular category of data.

Similar to virtual warehouse 1 discussed above, virtual warehouse 2 includes three execution nodes 312-1, 312-2, and 312-N. Execution node 312-1 includes a cache 314-1 and a processor 316-1. Execution node 312-2 includes a cache 314-2 and a processor 316-2. Execution node 312-N includes a cache 314-N and a processor 316-N. Additionally, virtual warehouse 3 includes three execution nodes 322-1, 322-2, and 322-N. Execution node 322-1 includes a cache 324-1 and a processor 326-1. Execution node 322-2 includes a cache 324-2 and a processor 326-2. Execution node 322-N includes a cache 324-N and a processor 326-N.

In some embodiments, the execution nodes shown in FIG. 3 are stateless with respect to the data being cached by the execution nodes. For example, these execution nodes do not store or otherwise maintain state information about the execution node or the data being cached by a particular execution node. Thus, in the event of an execution node failure, the failed node can be transparently replaced by another node. Since there is no state information associated with the failed execution node, the new (replacement) execution node can easily replace the failed node without concern for recreating a particular state.

Although the execution nodes shown in FIG. 3 each includes one data cache and one processor, alternative embodiments may include execution nodes containing any number of processors and any number of caches. Additionally, the caches may vary in size among the different execution nodes. The caches shown in FIG. 3 store, in the local execution node, data that was retrieved from one or more data storage devices in the cloud storage platform 104. Thus, the caches reduce or eliminate the bottleneck problems occurring in platforms that consistently retrieve data from remote storage systems. Instead of repeatedly accessing data from the remote storage devices, the systems and methods described herein access data from the caches in the execution nodes, which is significantly faster and avoids the bottleneck problem discussed above. In some embodiments, the caches are implemented using high-speed memory devices that provide fast access to the cached data. Each cache can store data from any of the storage devices in the cloud storage platform 104.

Further, the cache resources and computing resources may vary between different execution nodes. For example, one execution node may contain significant computing resources and minimal cache resources, making the execution node useful for tasks that require significant computing resources. Another execution node may contain significant cache resources and minimal computing resources, making this execution node useful for tasks that require caching of large amounts of data. Yet another execution node may contain cache resources providing faster input-output operations, useful for tasks that require fast scanning of large amounts of data. In some embodiments, the cache resources and computing resources associated with a particular execution node are determined when the execution node is created, based on the expected tasks to be performed by the execution node.

Additionally, the cache resources and computing resources associated with a particular execution node may change over time based on changing tasks performed by the execution node. For example, an execution node may be assigned more processing resources if the tasks performed by the execution node become more processor-intensive. Similarly, an execution node may be assigned more cache resources if the tasks performed by the execution node require a larger cache capacity. Further, some nodes may be executing much slower than others due to various issues (e.g., virtualization issues and network overhead). In some example embodiments, the imbalances are addressed at the scan level using a file-stealing scheme. In particular, whenever a node process completes scanning its set of input files, it requests additional files from other nodes. If one of the other nodes receives such a request, the node analyzes its own set (e.g., how many files are left in the input file set when the request is received), and then transfers ownership of one or more of the remaining files for the duration of the current job (e.g., query). The requesting node (e.g., the file stealing node) then receives the data (e.g., header data) and downloads the files from the cloud storage platform 104 (e.g., from data storage device 120-1), and does not download the files from the transferring node. In this way, lagging nodes can transfer files via file stealing in a way that does not worsen the load on the lagging nodes.

Although virtual warehouses 1, 2, and N are associated with the same execution platform 110, virtual warehouses 1, . . . , N may be implemented using multiple computing systems at multiple geographic locations. For example, virtual warehouse 1 can be implemented by a computing system at a first geographic location, while virtual warehouses 2 and N are implemented by another computing system at a second geographic location. In some embodiments, these different computing systems are cloud-based computing systems maintained by one or more different entities.

Additionally, each virtual warehouse is shown in FIG. 3 as having multiple execution nodes. The multiple execution nodes associated with each virtual warehouse may be implemented using multiple computing systems at multiple geographic locations. For example, an instance of virtual warehouse 1 implements execution nodes 302-1 and 302-2 on one computing platform at a geographic location, and execution node 302-N at a different computing platform at another geographic location. Selecting particular computing systems to implement an execution node may depend on various factors, such as the level of resources needed for a particular execution node (e.g., processing resource requirements and cache requirements), the resources available at particular computing systems, communication capabilities of networks within a geographic location or between geographic locations, and which computing systems are already implementing other execution nodes in the virtual warehouse.

Execution platform 110 is also fault-tolerant. For example, if one virtual warehouse fails, that virtual warehouse is quickly replaced with a different virtual warehouse at a different geographic location.

A particular execution platform 110 may include any number of virtual warehouses. Additionally, the number of virtual warehouses in a particular execution platform is dynamic, such that new virtual warehouses are created when additional processing and/or caching resources are needed. Similarly, existing virtual warehouses may be deleted when the resources associated with the virtual warehouse are no longer necessary.

In some embodiments, the virtual warehouses may operate on the same data in the cloud storage platform 104, but each virtual warehouse has its execution nodes with independent processing and caching resources. This configuration allows requests on different virtual warehouses to be processed independently and with no interference between the requests. This independent processing, combined with the ability to dynamically add and remove virtual warehouses, supports the addition of new processing capacity for new users without impacting the performance observed by the existing users.

FIG. 4 is a block diagram of an example adversary alerting and processing system (ALPS) 400 which can be used within the network-based database system of FIG. 1, according to some example embodiments. Referring to FIG. 4, one or more of the AAP functionalities of ALPS 400 discussed herein can be configured and performed by the AAP manager 134. For example, the AAP manager 134 can configure and generate the duplicate staging and production tables 417 used in connection with the AAP functionalities of ALPS 400.

In operation, log sources 402 generate logs which are stored in the raw event storage table 414. The data formatting manager 404 ingests the log data from the raw events storage table 414 and performs log data processing (e.g., modeling and testing including freshness testing) to generate processed log data. The alerts generator 406 uses one or more pre-configured filters to filter the processed log data and detect at least one security alert, which is stored in the log-based alerts table 416. For example, the alerts generator 406 can be Panther®-based and the log-based alerts can include Panther® alerts associated with user access to a network functionality or other types of network-related alerts including cybersecurity-related alerts.

The email client 408 can be configured to provide email services including security mailbox monitoring 434. In some aspects, a phishing attempt may be detected during the security mailbox monitoring 434 and a corresponding phishing report 436 can be generated. In some aspects, the phishing report 436 is generated based on user input after receiving an email via the email client 408. In some aspects, the phishing report 436 includes information identifying the sender of the phishing email (e.g., name, email, IP address, domain, etc.), the receiver's email address, the phishing email contents, etc.

The phishing report 436 can be provided to the security client 410 used by analyst 412. More specifically, the automation manager 438 detects the phishing report 436 and adds a corresponding security alert into the aggregated alerts table 418. The aggregated alerts table 418 within the duplicate staging and production tables 417 ingests the log-based alerts from the log-based alerts table 416 in addition to the alerts generated by the automation manager 438. The ALPS alerts in the aggregated alerts table can be associated with a 1-to-many relationship with the cases table 420.

Cases table 420 within the duplicate staging and production tables 417 stores data about cases related to security alerts (e.g., case title, status, priority, person-hours spent in resolving the case, etc.). A case can be related to a single alert or multiple alerts (e.g., multiple alerts associated with the same user or with the same network access violation or network communication sent by the same sender to different recipients). In some aspects, the automation manager 438 is configured to perform correlation of alerts stored in the aggregated alerts table 418 to detect such multiple alerts that can be associated with a single case.

The observables table 422 within the duplicate staging and production tables 417 stores evidence data (also referred to as indicators of compromise or IOC) related to an alert. Examples of evidence data associated with an alert include IP addresses, file hashes (e.g., MD5, SHA1, SHA256), domains, URLs, email addresses, etc. Data in the observables table 422 can be both auto-extracted by the automation manager 438 or manually input by analyst 412.

The involved users table 424 within the duplicate staging and production tables 417 stores data stores information about users who are involved in each alert. Involved users can be both auto-extracted by the automation manager 438 or manually input by analyst 412. For example, an email address (or other user identification information) can be extracted from the alert and stored in the involved users table. The AAP manager 134 can then enrich such data using the enrichment data tables 432 of the security data lake 430. For example, the extracted email address can be enriched with the user's full name, title, work location, information on whether the user can be considered a high-value employee, as well as other security-related enrichment data associated with the user.

The compromises table 426 within the duplicate staging and production tables 417 stores data about users, hosts, or credentials that have been compromised as a result of a network security incident associated with the corresponding alert (or case). Similarly to the involved users table 424, when a user email address is extracted from the alert, the AAP manager 134 can enrich the data using the enrichment data tables 432, providing information regarding the user/host/credentials that were compromised.

The case notes table 428 within the duplicate staging and production tables 417 stores data stores documentation (or other input) received from the analyst 412 regarding the corresponding case via the user interface (UI) manager 440. Any observations, findings, analysis, and/or communications can be input into comments in the case (within the cases table 420) and also stored in the case notes table 428.

In some aspects, the AAP manager 134 can configure the security client 410 (e.g., the automation manager 438) to automatically select and perform a remediation action (e.g., add a network filter to block certain network traffic associated with the alert, block the email address or email domain of the violating user sending a phishing email or otherwise causing a network cybersecurity violation associated with the alert, etc.). In some embodiments, the remediation action can be based on input from analyst 412 via the UI manager 440. In some embodiments, the case notes table 428 and the case record in the cases table 420 are updated with the remediation action that is performed, and one or more notifications of the completed remediation action can be communicated (e.g., to one or more of the involved users associated with the alert and retrieved from the involved users table 424).

FIG. 5, FIG. 6, FIG. 7, and FIG. 8 are flow diagrams illustrating the operations of an adversary alerting and processing manager in performing methods 500, 600, 700, and 800 for processing security alerts, according to some example embodiments.

Methods 500, 600, 700, and 800 may be embodied in computer-readable instructions for execution by one or more hardware components (e.g., one or more processors) such that the operations of methods 500, 600, 700, and 800 may be performed by components of the network-based database system 102, such as a network node (e.g., the AAP manager 134 executing on a network node of the compute service manager 108) or a computing device (e.g., client device 114) which may be implemented as machine 900 of FIG. 9 performing the disclosed functions. Accordingly, methods 500, 600, 700, and 800 are described below, by way of example with reference thereto. However, it shall be appreciated that methods 500, 600, 700, and 800 may be deployed on various other hardware configurations and are not intended to be limited to deployment within the network-based database system 102.

Referring to FIG. 5, method 500 includes processing operations 502-510. At operation 502, log data associated with user access to network functionality is retrieved (e.g., log data as processed by the data formatting manager 404).

At operation 504, at least one security alert associated with the user access is generated based on the log data. For example, at least one alert is generated by the alerts generator 406 and stored in the log-based alerts table 416 and the aggregated alerts table 418.

At operation 506, one or more indicators of compromise (IOC) and identification information of the user are extracted from the at least one security alert. For example, the AAP manager 134 can extract such information using, e.g., the automation manager 438.

At operation 508, enriched metadata of the user is generated based on the identification information. For example, enrichment data can be retrieved from the enrichment data tables 432 and used to enrich data stored in the observables table 422 and the involved users table 424.

At operation 510, a remediation action for the at least one security alert is performed based at least on the one or more indicators of compromise and the enriched metadata (e.g., as stored in the observables table 422 and the involved users table 424).

Referring to FIG. 6, method 600 includes processing operations 602-620 associated with processing an alert related to a unique email case. At operation 602, an email is detected in a shared security mailbox (e.g., of email client 408) from a user who has reported the email as suspicious. At operation 604, the email is ingested into the aggregated alerts table 418 via the automation manager 438 and an alert is generated. Since the email is unique and not correlated to any other case, at operation 606, a case is generated based on the alert (e.g., a one-to-one relationship of alert to a case in this scenario).

At operation 608, the automation manager 438 examines the email and extracts any possible observables (e.g., IOC), and stores them in the observables table 422 at operation 610. At operation 612, user information (e.g., associated with the user who reported the email) is extracted by the automation manager 438. At operation 614, the user information is enriched with relevant employee data and is inserted into the involved users table 424. At operation 616, the case can be added to an ALPS ticket queue (e.g., of service tickets related to AAP) and is assigned to analyst 412. Analyst 412 can analyze the email and can generate notes. At operation 618, the notes are stored in case notes table 428. At operation 620, case information stored in the cases table 420 is updated based on a remediation action that is assigned (or already performed) in response to the alert. For example, corresponding fields within the cases table 420 are updated (e.g., status, priority, or other fields) when analyst 412 concludes the case and closes it.

Referring to FIG. 7, method 700 includes processing operations 702-722 associated with processing an alert related to a duplicate email case. At operation 702, an email is detected in a shared security mailbox (e.g., of email client 408) from a user who has reported the email as suspicious. At operation 704, the email is ingested into the aggregated alerts table 418 via the automation manager 438 and an alert is generated. The automation manager 438 can detect the email was received from the same sender with the same subject as a previously reported email received by a different user. At operation 706, the automation manager 438 correlates the alert to the existing case. At operation 708, the automation manager 438 adds the alert ID of the current alert to the existing case so both alerts are viewable from the existing case (e.g., two alerts correspond to one case in this example). The same flow as above would then take effect in the auto-extractions and the analyst documenting what took place.

At operation 710, the automation manager 438 examines the email and extracts any possible observables (e.g., IOC), and stores them in the observables table 422 (at operation 712). At operation 714, user information (e.g., associated with the user who reported the email) is extracted by the automation manager 438. At operation 716, the user information is enriched with relevant employee data and is inserted into the involved users table 424. At operation 718, the case can be added to an ALPS ticket queue (e.g., of service tickets related to AAP) and is assigned to analyst 412. Analyst 412 can analyze the email and can generate notes. At operation 720, the notes are stored in the case notes table 428. At operation 722, case information stored in the cases table 420 is updated based on a remediation action that is assigned (or already performed) in response to the alert. For example, corresponding fields within the cases table 420 are updated (e.g., status, priority, or other fields) when analyst 412 concludes the case and closes it.

In the above example of method 700, the AAP manager 134 can be used to better track a phishing campaign under a single case, regardless of the number of similarly reported emails. In this regard, multiple users would be extracted, the corresponding user data enriched and placed in the involved users table 424 which would be viewable from the single case.

Referring to FIG. 8, method 800 includes processing operations 802-820 associated with processing multiple alerts about a single user.

At operation 802, multiple network alerts associated with the network activity of a single user are detected. For example, within a given window of when alert detection runs, a user has suspicious network activity that occurs on their machine, which activity triggers multiple detections and multiple alerts. For example, the user had a suspicious process run on their computer, suspicious network activity, and a successful login to a machine that was never accessed before by that user. Each of those alerts can be written to the log-based alerts table 416 and then copied into the aggregated alerts table 418. At operation 804, the automation manager 438 detects that each of the alerts does not correlate to an existing case, but they all correlate to each other. Consequently, at operation 806, a new single case is opened in the cases table 420 and the new alerts are input into the single case. The new alerts can be viewable in an ALPS ticket queue (which can be maintained by the security client 410). Similar extractions and enrichment to the email cases will run on this case, extracting any pertinent observables and involved users, enriching that data, and storing it in the observables and involved users tables respectively. An analyst will pick up the case and analyze/document the happenings with the data which can be stored in the case notes table. If the user's account and/or computer were deemed compromised, that data would be input into the compromises table 426. Upon completing the analysis/investigation, the necessary fields would be populated in the cases table and the case would be closed. The example operations flow is listed below.

At operation 808, the automation manager 438 examines the alerts and extracts any possible observables (e.g., IOC), and stores them in the observables table 422 (e.g., at operation 810). At operation 812, user information (e.g., associated with the user performing the network activity) is extracted by the automation manager 438. At operation 814, the user information is enriched with relevant employee data and is inserted into the involved users table 424. At operation 816, the case can be added to an ALPS ticket queue (e.g., of service tickets related to AAP) and is assigned to analyst 412. Analyst 412 can analyze the email and can generate notes. At operation 818, the notes are stored in the case notes table 428. At operation 820, case information stored in the cases table 420 is updated based on a remediation action that is assigned (or already performed) in response to the alert. For example, corresponding fields within the cases table 420 are updated (e.g., status, priority, or other fields) when analyst 412 concludes the case and closes it.

FIG. 9 illustrates a diagrammatic representation of machine 900 in the form of a computer system within which a set of instructions may be executed for causing machine 900 to perform any one or more of the methodologies discussed herein, according to an example embodiment. Specifically, FIG. 9 shows a diagrammatic representation of machine 900 in the example form of a computer system, within which instructions 916 (e.g., software, a program, an application, an applet, an app, or other executable code) for causing the machine 900 to perform any one or more of the methodologies discussed herein may be executed. For example, instructions 916 may cause machine 900 to execute any one or more operations of methods 500, 600, 700, and 800 (or any other technique discussed herein, for example in connection with FIGS. 4-8). As another example, instructions 916 may cause machine 900 to implement one or more portions of the functionalities discussed herein. In this way, instructions 916 may transform a general, non-programmed machine into a particular machine 900 (e.g., the client device 114, the compute service manager 108, or a node in the execution platform 110) that is specially configured to carry out any one of the described and illustrated functions in the manner described herein. In yet another embodiment, instructions 916 may configure the client device 114, the compute service manager 108, and/or a node in the execution platform 110 to carry out any one of the described and illustrated functions in the manner described herein, which functions can be configured or performed by the AAP manager 134.

In alternative embodiments, the machine 900 operates as a standalone device or may be coupled (e.g., networked) to other machines. In a networked deployment, machine 900 may operate in the capacity of a server machine or a client machine in a server-client network environment, or as a peer machine in a peer-to-peer (or distributed) network environment. The machine 900 may comprise, but not be limited to, a server computer, a client computer, a personal computer (PC), a tablet computer, a laptop computer, a netbook, a smartphone, a mobile device, a network router, a network switch, a network bridge, or any machine capable of executing the instructions 916, sequentially or otherwise, that specify actions to be taken by the machine 900. Further, while only a single machine 900 is illustrated, the term “machine” shall also be taken to include a collection of machines that individually or jointly execute instructions 916 to perform any one or more of the methodologies discussed herein.

Machine 900 includes processors 910, memory 930, and input/output (I/O) components 950 configured to communicate with each other such as via a bus 902. In some example embodiments, the processors 910 (e.g., a central processing unit (CPU), a reduced instruction set computing (RISC) processor, a complex instruction set computing (CISC) processor, a graphics processing unit (GPU), a digital signal processor (DSP), an application-specific integrated circuit (ASIC), a radio-frequency integrated circuit (RFIC), another processor, or any suitable combination thereof) may include, for example, a processor 912 and a processor 914 that may execute the instructions 916. The term “processor” is intended to include multi-core processors 910 that may comprise two or more independent processors (sometimes referred to as “cores”) that may execute instructions 916 contemporaneously. Although FIG. 9 shows multiple processors 910, machine 900 may include a single processor with a single core, a single processor with multiple cores (e.g., a multi-core processor), multiple processors with a single core, multiple processors with multiple cores, or any combination thereof.

The memory 930 may include a main memory 932, a static memory 934, and a storage unit 936, all accessible to the processors 910 such as via the bus 902. The main memory 932, the static memory 934, and the storage unit 936 store the instructions 916 embodying any one or more of the methodologies or functions described herein. The instructions 916 may also reside, completely or partially, within the main memory 932, within the static memory 934, within machine storage medium 938 of the storage unit 936, within at least one of the processors 910 (e.g., within the processor's cache memory), or any suitable combination thereof, during execution thereof by the machine 900.

The I/O components 950 include components to receive input, provide output, produce output, transmit information, exchange information, capture measurements, and so on. The specific I/O components 950 that are included in a particular machine 900 will depend on the type of machine. For example, portable machines such as mobile phones will likely include a touch input device or other such input mechanisms, while a headless server machine will likely not include such a touch input device. It will be appreciated that the I/O components 950 may include many other components that are not shown in FIG. 9. The I/O components 950 are grouped according to functionality merely for simplifying the following discussion and the grouping is in no way limiting. In various example embodiments, the I/O components 950 may include output components 952 and input components 954. The output components 952 may include visual components (e.g., a display such as a plasma display panel (PDP), a light-emitting diode (LED) display, a liquid crystal display (LCD), a projector, or a cathode ray tube (CRT)), acoustic components (e.g., speakers), other signal generators, and so forth. The input components 954 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures or other tactile input components), audio input components (e.g., a microphone), and the like.

Communication may be implemented using a wide variety of technologies. The I/O components 950 may include communication components 964 operable to couple the machine 900 to a network 980 or devices 970 via a coupling 982 and a coupling 972, respectively. For example, communication components 964 may include a network interface component or another suitable device to interface with network 980. In further examples, communication components 964 may include wired communication components, wireless communication components, cellular communication components, and other communication components to provide communication via other modalities. The device 970 may be another machine or any of a wide variety of peripheral devices (e.g., a peripheral device coupled via a universal serial bus (USB)). For example, as noted above, machine 900 may correspond to any one of the client devices 114, the compute service manager 108, or the execution platform 110, and device 970 may include the client device 114 or any other computing device described herein as being in communication with the network-based database system 102 or the cloud storage platform 104.

The various memories (e.g., 930, 932, 934, and/or memory of the processor(s) 910 and/or the storage unit 936) may store one or more sets of instructions 916 and data structures (e.g., software) embodying or utilized by any one or more of the methodologies or functions described herein. These instructions 916, when executed by the processor(s) 910, cause various operations to implement the disclosed embodiments.

As used herein, the terms “machine-storage medium,” “device-storage medium,” and “computer-storage medium” mean the same thing and may be used interchangeably in this disclosure. The terms refer to single or multiple storage devices and/or media (e.g., a centralized or distributed database, and/or associated caches and servers) that store executable instructions and/or data. The terms shall accordingly be taken to include, but not be limited to, solid-state memories, and optical and magnetic media, including memory internal or external to processors. Specific examples of machine-storage media, computer-storage media, and/or device-storage media include non-volatile memory, including by way of example semiconductor memory devices, e.g., erasable programmable read-only memory (EPROM), electrically erasable programmable read-only memory (EEPROM), field-programmable gate arrays (FPGAs), and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

In various example embodiments, one or more portions of the network 980 may be an ad hoc network, an intranet, an extranet, a virtual private network (VPN), a local-area network (LAN), a wireless LAN (WLAN), a wide-area network (WAN), a wireless WAN (WWAN), a metropolitan-area network (MAN), the Internet, a portion of the Internet, a portion of the public switched telephone network (PSTN), a plain old telephone service (POTS) network, a cellular telephone network, a wireless network, a Wi-Fi® network, another type of network, or a combination of two or more such networks. For example, network 980 or a portion of network 980 may include a wireless or cellular network, and coupling 982 may be a Code Division Multiple Access (CDMA) connection, a Global System for Mobile communications (GSM) connection, or another type of cellular or wireless coupling. In this example, the coupling 982 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth-generation wireless (4G) networks, Universal Mobile Telecommunications System (UMTS), High-Speed Packet Access (HSPA), Worldwide Interoperability for Microwave Access (WiMAX), Long Term Evolution (LTE) standard, others defined by various standard-setting organizations, other long-range protocols, or other data transfer technology.

The instructions 916 may be transmitted or received over the network 980 using a transmission medium via a network interface device (e.g., a network interface component included in the communication components 964) and utilizing any one of several well-known transfer protocols (e.g., hypertext transfer protocol (HTTP)). Similarly, instructions 916 may be transmitted or received using a transmission medium via coupling 972 (e.g., a peer-to-peer coupling or another type of wired or wireless network coupling) to device 970. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 916 for execution by the machine 900, and include digital or analog communications signals or other intangible media to facilitate communication of such software. Hence, the terms “transmission medium” and “signal medium” shall be taken to include any form of a modulated data signal, carrier wave, and so forth. The term “modulated data signal” means a signal that has one or more of its characteristics set or changed in such a manner as to encode information in the signal.

The terms “machine-readable medium,” “computer-readable medium,” and “device-readable medium” mean the same thing and may be used interchangeably in this disclosure. The terms are defined to include both machine-storage media and transmission media. Thus, the terms include both storage devices/media and carrier waves/modulated data signals.

The various operations of example methods described herein may be performed, at least partially, by one or more processors that are temporarily configured (e.g., by software) or permanently configured to perform the relevant operations. Similarly, the methods described herein may be at least partially processor-implemented. For example, at least some of the operations of the disclosed methods may be performed by one or more processors. The performance of certain operations may be distributed among the one or more processors, not only residing within a single machine but also deployed across several machines. In some example embodiments, the processor or processors may be located in a single location (e.g., within a home environment, an office environment, or a server farm), while in other embodiments the processors may be distributed across several locations.

Described implementations of the subject matter can include one or more features, alone or in combination as illustrated below by way of examples.

Example 1 is a system comprising: at least one hardware processor; and at least one memory storing instructions that cause the at least one hardware processor to perform operations comprising: retrieving log data associated with user access to a network functionality; generating at least one security alert associated with the user access based on the log data; extracting one or more indicators of compromise and identification information of a user from the at least one security alert; generating enriched metadata of the user based on the identification information; and performing a remediation action for the at least one security alert based on the one or more indicators of compromise and the enriched metadata.

In Example 2, the subject matter of Example 1 includes subject matter where the at least one hardware processor further performs operations comprising: ingesting the at least one security alert into an aggregated alerts table, wherein the aggregated alerts table comprises a plurality of additional alerts.

In Example 3, the subject matter of Example 2 includes subject matter where the at least one hardware processor further performs operations comprising: performing a correlation of the at least one security alert with the plurality of additional alerts; and detecting at least one of the plurality of additional alerts is associated with the user access based on the correlation.

In Example 4, the subject matter of Example 3 includes subject matter where the at least one hardware processor further performs operations comprising: generating a case entry in a cases table based on the detecting, the case entry including information identifying the at least one security alert and the at least one of the plurality of additional alerts.

In Example 5, the subject matter of Example 4 includes subject matter where the at least one hardware processor further performs operations comprising: updating the case entry to indicate the at least one security alert and the at least one of the plurality of additional alerts are resolved based on the performing of the remediation action.

In Example 6, the subject matter of Examples 1-5 includes subject matter where the at least one hardware processor further performs operations comprising: extracting at least one of an Internet protocol (IP) addresses, at least one file hash, a domain, a uniform resource locator (URL), and an email address from the at least one security alert as the one or more indicators of compromise; and storing the one or more indicators of compromise in an observables table.

In Example 7, the subject matter of Examples 1-6 includes subject matter where the at least one hardware processor further performs operations comprising: extracting an email address of the user from the at least one security alert as the identification information of the user; and generating an entry in an involved users table, the entry including the email address of the user.

In Example 8, the subject matter of Example 7 includes subject matter where the at least one hardware processor further performs operations comprising: extracting enrichment data for the user using at least one enrichment database; and updating the entry in the involved users table using the enrichment data.

In Example 9, the subject matter of Example 8 includes subject matter where the at least one hardware processor further performs operations comprising: determining compromised information using the enrichment data, the compromised information including one or more of a compromised user, a compromised network host, and compromised network access credentials associated with the user access to the network functionality.

In Example 10, the subject matter of Example 9 includes subject matter where the at least one hardware processor further performs operations comprising: updating an entry in a compromises table based on the compromised information; and generating a case note entry in a case note table based on the entry in the involved users table and the entry in the compromises table.

Example 11 is a method comprising: retrieving, by at least one hardware processor, log data associated with user access to a network functionality; generating, by at least one hardware processor, at least one security alert associated with the user access based on the log data; extracting, by at least one hardware processor, one or more indicators of compromise and identification information of a user from the at least one security alert; generating, by at least one hardware processor, enriched metadata of the user based on the identification information; and performing, by at least one hardware processor, a remediation action for the at least one security alert based on the one or more indicators of compromise and the enriched metadata.

In Example 12, the subject matter of Example 11 includes, ingesting the at least one security alert into an aggregated alerts table, wherein the aggregated alerts table comprises a plurality of additional alerts.

In Example 13, the subject matter of Example 12 includes, performing a correlation of the at least one security alert with the plurality of additional alerts; and detecting at least one of the plurality of additional alerts is associated with the user access based on the correlation.

In Example 14, the subject matter of Example 13 includes, generating a case entry in a cases table based on the detecting, the case entry including information identifying the at least one security alert and the at least one of the plurality of additional alerts.

In Example 15, the subject matter of Example 14 includes, updating the case entry to indicate the at least one security alert and the at least one of the plurality of additional alerts are resolved based on the performing of the remediation action.

In Example 16, the subject matter of Examples 11-15 includes, extracting at least one of an Internet protocol (IP) addresses, at least one file hash, a domain, a uniform resource locator (URL), and an email address from the at least one security alert as the one or more indicators of compromise; and storing the one or more indicators of compromise in an observables table.

In Example 17, the subject matter of Examples 11-16 includes, extracting an email address of the user from the at least one security alert as the identification information of the user; and generating an entry in an involved users table, the entry including the email address of the user.

In Example 18, the subject matter of Example 17 includes, extracting enrichment data for the user using at least one enrichment database; and updating the entry in the involved users table using the enrichment data.

In Example 19, the subject matter of Example 18 includes, determining compromised information using the enrichment data, the compromised information including one or more of a compromised user, a compromised network host, and compromised network access credentials associated with the user access to the network functionality.

In Example 20, the subject matter of Example 19 includes, updating an entry in a compromises table based on the compromised information; and generating a case note entry in a case note table based on the entry in the involved users table and the entry in the compromises table.

Example 21 is a computer-storage medium comprising instructions that, when executed by one or more processors of a machine, configure the machine to perform operations comprising: retrieving log data associated with user access to a network functionality; generating at least one security alert associated with the user access based on the log data; extracting one or more indicators of compromise and identification information of a user from the at least one security alert; generating enriched metadata of the user based on the identification information; and performing a remediation action for the at least one security alert based on the one or more indicators of compromise and the enriched metadata.

In Example 22, the subject matter of Example 21 includes, the operations further comprising: ingesting the at least one security alert into an aggregated alerts table, wherein the aggregated alerts table comprises a plurality of additional alerts.

In Example 23, the subject matter of Example 22 includes, the operations further comprising: performing a correlation of the at least one security alert with the plurality of additional alerts; and detecting at least one of the plurality of additional alerts is associated with the user access based on the correlation.

In Example 24, the subject matter of Example 23 includes, the operations further comprising: generating a case entry in a cases table based on the detecting, the case entry including information identifying the at least one security alert and the at least one of the plurality of additional alerts.

In Example 25, the subject matter of Example 24 includes, the operations further comprising: updating the case entry to indicate the at least one security alert and the at least one of the plurality of additional alerts are resolved based on the performing of the remediation action.

In Example 26, the subject matter of Examples 21-25 includes, the operations further comprising: extracting at least one of an Internet protocol (IP) addresses, at least one file hash, a domain, a uniform resource locator (URL), and an email address from the at least one security alert as the one or more indicators of compromise; and storing the one or more indicators of compromise in an observables table.

In Example 27, the subject matter of Examples 21-26 includes, the operations further comprising: extracting an email address of the user from the at least one security alert as the identification information of the user; and generating an entry in an involved users table, the entry including the email address of the user.

In Example 28, the subject matter of Example 27 includes, the operations further comprising: extracting enrichment data for the user using at least one enrichment database; and updating the entry in the involved users table using the enrichment data.

In Example 29, the subject matter of Example 28 includes, the operations further comprising: determining compromised information using the enrichment data, the compromised information including one or more of a compromised user, a compromised network host, and compromised network access credentials associated with the user access to the network functionality.

In Example 30, the subject matter of Example 29 includes, the operations further comprising: updating an entry in a compromises table based on the compromised information; and generating a case note entry in a case note table based on the entry in the involved users table and the entry in the compromises table.

Example 31 is at least one machine-readable medium including instructions that, when executed by processing circuitry, cause the processing circuitry to perform operations to implement any of Examples 1-30.

Example 32 is an apparatus comprising means to implement any of Examples 1-30.

Example 33 is a system to implement any of Examples 1-30.

Example 34 is a method to implement any of Examples 1-30.

Although the embodiments of the present disclosure have been described concerning specific example embodiments, it will be evident that various modifications and changes may be made to these embodiments without departing from the broader scope of the inventive subject matter. Accordingly, the specification and drawings are to be regarded in an illustrative rather than a restrictive sense. The accompanying drawings that form a part hereof show, by way of illustration, and not of limitation, specific embodiments in which the subject matter may be practiced. The embodiments illustrated are described in sufficient detail to enable those skilled in the art to practice the teachings disclosed herein. Other embodiments may be used and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is disclosed. Thus, although specific embodiments have been illustrated and described herein, it should be appreciated that any arrangement calculated to achieve the same purpose may be substituted for the specific embodiments shown. This disclosure is intended to cover any adaptations or variations of various embodiments. Combinations of the above embodiments, and other embodiments not specifically described herein, will be apparent to those of skill in the art, upon reviewing the above description.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended; that is, a system, device, article, or process that includes elements in addition to those listed after such a term in a claim is still deemed to fall within the scope of that claim.

What is claimed is:

1. A system comprising:
at least one hardware processor; and
at least one memory storing instructions that cause the at least one hardware processor to perform operations comprising:
retrieving log data associated with user access to a network functionality;
generating at least one security alert associated with the user access based on the log data;
extracting one or more indicators of compromise and identification information of a user from the at least one security alert;
generating enriched metadata of the user based on the identification information; and
performing a remediation action for the at least one security alert based on the one or more indicators of compromise and the enriched metadata.

2. The system of claim 1, wherein the at least one hardware processor further performs operations comprising:
ingesting the at least one security alert into an aggregated alerts table, wherein the aggregated alerts table comprises a plurality of additional alerts.

3. The system of claim 2, wherein the at least one hardware processor further performs operations comprising:
performing a correlation of the at least one security alert with the plurality of additional alerts; and
detecting at least one of the plurality of additional alerts is associated with the user access based on the correlation.

4. The system of claim 3, wherein the at least one hardware processor further performs operations comprising:
generating a case entry in a cases table based on the detecting, the case entry including information identifying the at least one security alert and the at least one of the plurality of additional alerts.

5. The system of claim 4, wherein the at least one hardware processor further performs operations comprising:
updating the case entry to indicate the at least one security alert and the at least one of the plurality of additional alerts are resolved based on the performing of the remediation action.

6. The system of claim 1, wherein the at least one hardware processor further performs operations comprising:
extracting at least one of an Internet protocol (IP) addresses, at least one file hash, a domain, a uniform resource locator (URL), and an email address from the at least one security alert as the one or more indicators of compromise; and
storing the one or more indicators of compromise in an observables table.

7. The system of claim 1, wherein the at least one hardware processor further performs operations comprising:
extracting an email address of the user from the at least one security alert as the identification information of the user; and
generating an entry in an involved users table, the entry including the email address of the user.

8. The system of claim 7, wherein the at least one hardware processor further performs operations comprising:
extracting enrichment data for the user using at least one enrichment database; and
updating the entry in the involved users table using the enrichment data.

9. The system of claim 8, wherein the at least one hardware processor further performs operations comprising:
determining compromised information using the enrichment data, the compromised information including one or more of a compromised user, a compromised network host, and compromised network access credentials associated with the user access to the network functionality.

10. The system of claim 9, wherein the at least one hardware processor further performs operations comprising:
updating an entry in a compromises table based on the compromised information; and
generating a case note entry in a case note table based on the entry in the involved users table and the entry in the compromises table.

11. A method comprising:
retrieving, by at least one hardware processor, log data associated with user access to a network functionality;
generating, by at least one hardware processor, at least one security alert associated with the user access based on the log data;
extracting, by at least one hardware processor, one or more indicators of compromise and identification information of a user from the at least one security alert;
generating, by at least one hardware processor, enriched metadata of the user based on the identification information; and
performing, by at least one hardware processor, a remediation action for the at least one security alert based on the one or more indicators of compromise and the enriched metadata.

12. The method of claim 11, further comprising:
ingesting the at least one security alert into an aggregated alerts table, wherein the aggregated alerts table comprises a plurality of additional alerts.

13. The method of claim 12, further comprising:
performing a correlation of the at least one security alert with the plurality of additional alerts; and
detecting at least one of the plurality of additional alerts is associated with the user access based on the correlation.

14. The method of claim 13, further comprising:
generating a case entry in a cases table based on the detecting, the case entry including information identifying the at least one security alert and the at least one of the plurality of additional alerts.

15. The method of claim 14, further comprising:
updating the case entry to indicate the at least one security alert and the at least one of the plurality of additional alerts are resolved based on the performing of the remediation action.

16. The method of claim 11, further comprising:
extracting at least one of an Internet protocol (IP) addresses, at least one file hash, a domain, a uniform resource locator (URL), and an email address from the at least one security alert as the one or more indicators of compromise; and
storing the one or more indicators of compromise in an observables table.

17. The method of claim 11, further comprising:
extracting an email address of the user from the at least one security alert as the identification information of the user; and
generating an entry in an involved users table, the entry including the email address of the user.

18. The method of claim 17, further comprising:
extracting enrichment data for the user using at least one enrichment database; and
updating the entry in the involved users table using the enrichment data.

19. The method of claim 18, further comprising:
determining compromised information using the enrichment data, the compromised information including one or more of a compromised user, a compromised network host, and compromised network access credentials associated with the user access to the network functionality.

20. The method of claim 19, further comprising:
updating an entry in a compromises table based on the compromised information; and
generating a case note entry in a case note table based on the entry in the involved users table and the entry in the compromises table.

21. A computer-storage medium comprising instructions that, when executed by one or more processors of a machine, configure the machine to perform operations comprising:
retrieving log data associated with user access to a network functionality;
generating at least one security alert associated with the user access based on the log data;
extracting one or more indicators of compromise and identification information of a user from the at least one security alert;
generating enriched metadata of the user based on the identification information; and
performing a remediation action for the at least one security alert based on the one or more indicators of compromise and the enriched metadata.

22. The computer-storage medium of claim 21, the operations further comprising:
ingesting the at least one security alert into an aggregated alerts table, wherein the aggregated alerts table comprises a plurality of additional alerts.

23. The computer-storage medium of claim 22, the operations further comprising:
performing a correlation of the at least one security alert with the plurality of additional alerts; and
detecting at least one of the plurality of additional alerts is associated with the user access based on the correlation.

24. The computer-storage medium of claim 23, the operations further comprising:
generating a case entry in a cases table based on the detecting, the case entry including information identifying the at least one security alert and the at least one of the plurality of additional alerts.

25. The computer-storage medium of claim 24, the operations further comprising:
updating the case entry to indicate the at least one security alert and the at least one of the plurality of additional alerts are resolved based on the performing of the remediation action.

26. The computer-storage medium of claim 21, the operations further comprising:
extracting at least one of an Internet protocol (IP) addresses, at least one file hash, a domain, a uniform resource locator (URL), and an email address from the at least one security alert as the one or more indicators of compromise; and
storing the one or more indicators of compromise in an observables table.

27. The computer-storage medium of claim 21, the operations further comprising:
extracting an email address of the user from the at least one security alert as the identification information of the user; and
generating an entry in an involved users table, the entry including the email address of the user.

28. The computer-storage medium of claim 27, the operations further comprising:
extracting enrichment data for the user using at least one enrichment database; and
updating the entry in the involved users table using the enrichment data.

29. The computer-storage medium of claim 28, the operations further comprising:
determining compromised information using the enrichment data, the compromised information including one or more of a compromised user, a compromised network host, and compromised network access credentials associated with the user access to the network functionality.

30. The computer-storage medium of claim 29, the operations further comprising:
updating an entry in a compromises table based on the compromised information; and
generating a case note entry in a case note table based on the entry in the involved users table and the entry in the compromises table.
